(19) United States
(12) Patent Application Publication
(10) Pub. No.: US 2026/0125618 A1
(43) Pub. Date: May 7, 2026

(54) DETERGENT GRANULES CONTAINING PRECIPITATED CALCIUM CARBONATE

(71) Applicant: The Procter & Gamble Company, Cincinnati, OH (US)

(72) Inventors: Xiao TIAN, Beijing (CN); Qianqian JIANG, Beijing (CN); Dan XU, Beijing (CN)

(21) Appl. No.: 19/375,755

(22) Filed: Oct. 31, 2025

(30) Foreign Application Priority Data
Nov. 1, 2024 (WO) PCT/CN2024/129282
Sep. 24, 2025 (WO) PCT/CN2025/123606

(51) Int. Cl. C11D 3/10; C11D 1/14; C11D 3/04; C11D 3/386; C11D 17/06

(52) U.S. Cl. CPC C11D 3/10; C11D 1/143; C11D 1/146; C11D 3/046; C11D 3/386; C11D 17/06; C11D 2111/12

(57) ABSTRACT

This disclosure is related to detergent granules containing precipitated calcium carbonate, as well as a solid detergent composition comprising such detergent granules.

### FIELD OF THE INVENTION

This invention relates to detergent granules containing precipitated calcium carbonate in a format of agglomerates.

### BACKGROUND OF THE INVENTION

Granular detergent compositions of today are incorporating larger amounts and greater varieties of cleaning actives, which enable a myriad of benefits including superior cleaning, sensorial, environmental sustainability, convenience, and efficiency.

However, there are still challenges in manufacturing of products comprising detergent granules with such large amounts and different varieties of cleaning actives. One of key challenges is to improve the flowability because the manufacturing process cannot proceed smoothly if the granules do not have an appropriate flowability. In addition to flowability, during the agglomeration process, another key challenge is to reduce over-sized particles because over-sized particles would result in increased cost and/or increased processing period.

In order to improve the flowability of such detergent granules, flow aids such as aluminosilicates (e.g., zeolite), silicon dioxide (e.g., silica), bentonite, and clay have been introduced into detergent granules. However, the over-sized particles are still an issue to be solved. Accordingly, there is a continuing need to identify new materials that provide reduced over-sized particles in agglomeration process.

### SUMMARY OF THE INVENTION

Surprisingly, the inventors discovered that the addition of precipitated calcium carbonate (PCC) in raw materials of agglomeration can provide both a desirable flowability and a reduced over-sized particles compared to common flow aids, e.g. zeolite. As such, in one aspect, the present invention relates to a solid detergent composition comprising a plurality of detergent granules in a format of agglomerates, extruded particles or flakes, wherein said each of said detergent granule comprises a surfactant system and precipitated calcium carbonate, wherein said detergent granules are characterized by a surfactant system content ranging from 5% to 90% and a precipitated calcium carbonate content ranging from 0.1% to 15%, by total weight of said detergent granules, wherein the surfactant system and the precipitated calcium carbonate are present in a form of mixture within the detergent granules, wherein said surfactant system comprises a C₁₀-C₂₀ linear alkyl benzene sulphonate (LAS), wherein the weight ratio of LAS to PCC is from 2.1 to 15, wherein said detergent granules comprise less than 2%, by total weight of said detergent granules, of an additional flow aid which is selected from the group consisting of aluminosilicates, silicon dioxide, bentonite, clay, ground sodium carbonate, carboxymethyl cellulose (CMC) and any combinations thereof.

In some embodiments, said precipitated calcium carbonate is characterized by:
a bulk density ranging from 100 g/L to 1000 g/L, preferably from 150 g/L to 800 g/L, more preferably from 200 g/L to 600 g/L, most preferably from 250 g/L to 400 g/L; and/or
a particle size distribution characterized by: (1) a D50 ranging from 0.1 micron to 50 microns, preferably from 0.5 microns to 20 microns, more preferably from 1 micron to 10 microns, most preferably from 2 microns to 5 microns; and/or (2) a D90 of less than 50 microns, preferably less than 20 microns, more preferably less than 15 microns, most preferably less than 10 microns; and/or
a moisture content of less than 3%, preferably less than 2%, more preferably less than 1%, most preferably less than 0.5%; and/or
a surface area of from 1 m²/g to 20 m²/g, preferably from 2 m²/g to 15 m²/g, preferably from 3 m²/g to 10 m²/g, more preferably from 3.5 m²/g to 9 m²/g.

In some embodiments, the weight ratio of LAS to PCC is from 2.5 to 12, preferably from 3 to 10, more preferably from 3 to 8, most preferably from 3 to 5.5, for example, 2.5, 3, 3.5, 4, 4.5, 5, 5.5, 6, 7, 8, 9, 10, 11, 12 or any ranges therebetween.

In some embodiments, the precipitated calcium carbonate content ranges from 0.1% to 12%, preferably from 0.5% to 10%, more preferably from 1% to 8%, most preferably from 2% to 7%, for example 1.5%, 2%, 2.5%, 3%, 3.5%, 4%, 5%, 6%, 7%, 8%, 9% or any ranges therebetween, by total weight of said detergent granules.

In some embodiments, the surfactant system content ranges from 8% to 70%, preferably from 12% to 60%, more preferably from 18% to 50%, most preferably from 20% to 40%, for example 20%, 25%, 30%, 35%, 40% or any ranges therebetween, by total weight of said detergent granules.

In some embodiments, the surfactant system comprises one or more anionic surfactants selected from the group consisting of: a C₁₀-C₂₀ linear or branched alkylalkoxylated sulfate (AAS) surfactant; a C₆-C₂₀ linear or branched unalkoxylated alkyl sulfate (AS) surfactant; a C₁₀-C₂₀ linear alkyl benzene sulphonate (LAS) surfactant; and combinations thereof.

In some embodiments, each of said detergent granules further comprises alkali metal carbonate. Preferably, the content of alkali metal carbonate ranges from 1% to 85%, preferably from 5% to 75%, more preferably from 10% to 65%, most preferably from 15% to 60%, e.g., 15%, 20%, 25%, 30%, 35%, 40%, 45%, 50%, 55%, 60%, or any ranges therebetween, by total weight of said detergent granules.

In some embodiments, each of said detergent granules further comprises one or more filler salts, preferably sodium sulfate and/or sodium chloride. Preferably, the content of filler salts ranges from 1% to 85%, preferably from 5% to 75%, more preferably from 10% to 65%, most preferably from 15% to 60%, e.g., 15%, 20%, 25%, 30%, 35%, 40%, 45%, 50%, 55%, 60%, or any ranges therebetween, by total weight of said detergent granules.

In some embodiments, each of said detergent granules further comprises one or more ingredients selected from the group consisting of polymers, silicones, perfumes, nonionic surfactants, and combinations thereof. Preferably each of said detergent granules further comprises a mixture of perfume(s) and nonionic surfactant(s).

In some embodiments, each of said detergent granules further comprises one or more enzymes; and wherein preferably each of said detergent granules further comprises a lipase, a protease, an amylase, a cellulase, or any combinations thereof.

In some embodiments, the surfactant system and the precipitated calcium carbonate are mixed substantially homogeneously in the detergent granules.

In some embodiments, said detergent granules are characterized by:
a bulk density ranging from 200 g/L to 2000 g/L, preferably from 300 g/L to 1500 g/L, more preferably from 400 g/L to 1200 g/L, most preferably from 500 g/L to 1000 g/L, e.g. 500 g/L, 600 g/L, 700 g/L, 800 g/L, 900 g/L, 1000 g/L, or any ranges therebetween; and/or
a particle size distribution characterized by a D50 ranging from 10 micron to 1000 microns, preferably from 50 microns to 800 microns, more preferably from 100 micron to 700 microns, most preferably from 200 microns to 600 microns, e.g. 200 microns, 300 microns, 400 microns, 500 microns, 600 microns, or any ranges therebetween; and/or
an oversize % ranging from 2% to 20%, preferably from 3% to 19%, more preferably from 4% to 18%, most preferably from 5% to 17%, e.g. 5%, 6%, 7%, 8%, 9%, 10%, 11%, 12%, 13%, 14%, 15%, 16%, 17% or any ranges therebetween.

In some embodiments, the LAS ranges from 1% to 40%, preferably from 5% to 35%, more preferably from 10% to 30%, most preferably from 15% to 30%, for example, 10%, 15%, 20%, 25%, 30%, 35%, 40% or any ranges therebetween, by total weight of said detergent granules.

In some embodiments, said detergent granules comprise less than 1.5%, preferably from 0% to 1.5%, more preferably from 0% to 1%, by total weight of said detergent granules, of an additional flow aid which is selected from the group consisting of aluminosilicates, silicon dioxide, bentonite, clay, ground sodium carbonate, carboxymethyl cellulose (CMC) and any combinations thereof.

In some embodiments, said detergent granules are substantially free of an additional flow aid which is selected from the group consisting of aluminosilicates, silicon dioxide, bentonite, clay, ground sodium carbonate, carboxymethyl cellulose (CMC) and any combinations thereof.

In some embodiments, said detergent granules are substantially free of any coating made of an inorganic material which is selected from sodium carbonate, sodium sulfate, sodium chloride, silica and any combinations thereof.

In another aspect, the present invention is related to a method of making a solid detergent composition comprising a plurality of detergent granules, comprising the steps of: a) mixing a surfactant component and dry material into a high-speed mixer/densifier to obtain detergent agglomerates, wherein said dry material comprises precipitated calcium carbonate; and b) drying said detergent agglomerates in a fluid-bed dryer, wherein said detergent granules are characterized by a surfactant system content ranging from 5% to 90% and a precipitated calcium carbonate content ranging from 0.1% to 15%, by total weight of said detergent granules. Particularly, the surfactant component may be in a form of paste comprising one or more surfactants after neutralization, or the surfactant component may be in a form of liquid comprising one or more surfactants acids (e.g. HLAS) which will be neutralized during the drying step.

It is an advantage of the detergent granules containing precipitated calcium carbonates according to the present disclosure that can provide a desirable flowability and a reduced over-sized particles in agglomeration process compared to common flow aids.

It is another advantage of the detergent granules containing precipitated calcium carbonates according to the present disclosure that can provide a reduced amount of particulate residues on fabrics after washing compared to common flow aids.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

As used herein, articles such as “a” and “an” when used in a claim, are understood to mean one or more of what is claimed or described. The terms “include”, “includes” and “including” are meant to be non-limiting.

As used herein, the term “granule” or “particle” refers to a solid matter of minute quantity, such as a powder, granule, encapsulate, microcapsule, and/or prill. The detergent granules or base particles of the present invention can be spheres, rods, plates, tubes, squares, rectangles, discs, stars or flakes of regular or irregular shapes, but they are non-fibrous. The detergent granules or base particles of the present invention may have a median particle size (D50) of about 2000 μm or less, as measured according to the Particle Size Distribution Test described herein in Test 3. Preferably, the detergent granules or base particles of the present invention have a median particle size (D50) ranging from about 1 μm to about 2000 μm, more preferably from about 10 μm to about 1800 μm, still more preferably from about 50 μm to about 1700 μm, still more preferably from about 100 μm to about 1500 μm, still more preferably from about 250 μm to about 1000 μm, most preferably from about 300 μm to about 800 μm, as measured according to the Particle Size Distribution Test described herein in Test 3.

As used herein, the term “detergent granule” or “base particle” refers to granules or particles containing at least one surfactant, preferably at least one anionic surfactant.

As used herein, the term “mixture” means blend of two or more substances (e.g. the surfactant system and the precipitated calcium carbonate) that are physically intermingled rather than physically separated (e.g., a so-called core-coating structure).

As used herein, the term “coating layer” means a partial or complete coating of a layering material over the outer surfaces of a particulate or granular material, or at least a portion of such outer surfaces. Such coating layer can be either continuous or discontinuous.

As used herein, the term “a solid detergent composition” refers to a solid composition, such as granular or powder-form all-purpose or heavy-duty washing agents, e.g., for cleaning: (1) fabrics, dishes, and/or hard surface, which in such context include laundry detergents, dish detergents, hard surface cleansers as well as cleaning auxiliaries such as bleach, rinse aids, additives, or pre-treat types; (2) hair, hair follicles, skin, teeth, and the oral cavity, which in such context include hand cleansing products, teeth cleaning or treating products, oral cavity cleaning or treating products, hair shampoos or conditioners or other hair treatment products, body wash or other body cleansing products, shaving preparation products, personal care products, deodorizing products, and the like.

As used herein, the term “water-soluble” refers to the ability of a sample material to completely dissolve in or disperse into water leaving no visible solids or forming no visibly separate phase, when at least about 25 grams, preferably at least about 50 grams, more preferably at least about 100 grams, most preferably at least about 150 grams, of such material is placed in one liter (1 L) of deionized water at 20° C. and under the atmospheric pressure with sufficient stirring.

As used herein, the terms “consisting essentially of” means that the composition contains no ingredient that will interfere with benefits or functions of those ingredients that are explicitly disclosed. Further, the term “substantially free of” or “substantially free from” means that the indicated material is present in the amount of from 0 wt % to about 5 wt %, preferably from 0 wt % to 3 wt %. The term “essentially free of” means that the indicated material is present in the amount of from 0 wt % to about 1 wt %, preferably from 0 wt % to about 0.5 wt %, more preferably from 0 wt % to about 0.1 wt %, most preferably it is not present at analytically detectable levels.

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated. All polymer molecular weights are determined by weight average number molecular weight unless otherwise specifically noted.

### Precipitated Calcium Carbonate (PCC)

The precipitated calcium carbonate (PCC) contained in the detergent granule has a relatively low surface area, for example from 1 m²/g to 9 m²/g. Preferably, the PCC has a surface area of from 2 m²/g to 8 m²/g, preferably from 3 m²/g to 7 m²/g, more preferably from 3.5 m²/g to 6 m²/g.

The PCC suitable for use in the present invention can be prepared by any suitable precipitation process. For example, it can be prepared by a so-called carbonation process, in which gaseous carbon dioxide is passed into a suspension of calcium hydroxide that is derived from limestone. For another example, it can be formed by in-solution reaction between any soluble calcium salt (e.g., CaCl₂, CaSO₄ or CaOH₂) and any soluble carbonate salt (e.g., Na₂CO₃ or K₂CO₃), followed by a drying step. Furthermore, PCC can be formed by a so-called Slag2PCC process, in which steel converter slag, a waste material from the steelmaking industry, is used as a calcium source (rather than limestone).

In a preferred embodiment, the PCC used by the present invention is characterized by a bulk density ranging from 100 g/L to 1000 g/L, preferably from 150 g/L to 800 g/L, more preferably from 200 g/L to 600 g/L, most preferably from 250 g/L to 400 g/L, as measured by Test 1 hereinafter.

The PCC may be characterized, either in addition to or separately from the above-mentioned bulk density, by a surface area of from 2 m²/g to 8 m²/g, preferably from 3 m²/g to 7 m²/g, more preferably from 3.5 m²/g to 6 m²/g, for example, 3 m²/g, 3.5 m²/g, 4 m²/g, 4.5 m²/g, 5 m²/g, 5.5 m²/g, 6 m²/g or any ranges therebetween, as measured by Test 2 hereinafter.

The PCC may be characterized, either in addition to or separately from the above-mentioned bulk density and/or surface area, a particle size distribution characterized by: (1) a D50 ranging from 0.1 micron to 50 microns, preferably from 0.5 microns to 20 microns, more preferably from 1 micron to 10 microns, most preferably from 2 microns to 5 microns; and/or (2) a D90 of less than 50 microns, preferably less than 20 microns, more preferably less than 15 microns, most preferably less than 10 microns, as measured by Test 3 hereinafter.

The PCC as used in the present invention may have a moisture content of less than 3%, preferably less than 2%, more preferably less than 1%, most preferably less than 0.5%, as measure by Test 4 hereinafter.

### Agglomerate Particles

The agglomerate particles of the present disclosure loosely refer to any detersive granules or particles containing at least one surfactant, which is made through agglomeration process. The surfactant content in the agglomerate particles may range from 5% to 80%, preferably from 6% to 70%, more preferably from 8% to 60%, still more preferably from 10% to 50%, most preferably from 15% to 40%, for example 10%, 15%, 20%, 25%, 30%, 35%, 40%, 45%, 50% or any ranges therebetween, by total weight of said particles.

The agglomerate particles may comprise one or more surfactants selected from the group consisting of anionic surfactants, nonionic surfactants, zwitterionic surfactants, amphoteric surfactants, cationic surfactants, and combinations thereof.

Suitable anionic detersive surfactants include sulphonate and sulphate detersive surfactants. Suitable sulphonate detersive surfactants include methyl ester sulphonates, alpha olefin sulphonates, alkyl benzene sulphonates (especially alkyl benzene sulphonates, preferably C10-13 alkyl benzene sulphonate), alkyl sulphates, alkyl alkoxylated sulphates (preferably alkyl ethoxylated sulphates, preferably a C8-C18 alkyl alkoxylated sulphate, preferably a C8-C18 alkyl ethoxylated sulphate), and alkyl ether carboxylates. The alkyl sulphate, alkyl alkoxylated sulphate and alkyl benzene sulphonates may be linear or branched, substituted or un-substituted, and may be derived from petrochemical material or biomaterial. Suitable alkyl benzene sulphonate (LAS) is obtainable, preferably obtained, by sulphonating commercially available linear alkyl benzene (LAB). Suitable LAB includes low 2-phenyl LAB and high 2-phenyl LAB, such as those supplied by Sasol under the tradename Hyblene®. Suitable sulphate detersive surfactants include alkyl sulphate, preferably C8-C18 alkyl sulphate, or predominantly C-12 alkyl sulphate.

Preferably, the agglomerate particles comprise one or more anionic surfactants selected from the group consisting of: (1) a C10-C₂₀ linear or branched alkylalkoxylated sulfate (AAS) surfactant; (2) a C₆-C₂₀ linear or branched unalkoxylated alkyl sulfate (AS) surfactant; (3) a C10-C₂₀ linear alkyl benzene sulphonate (LAS) surfactant; and (4) combinations thereof. More preferably, the agglomerate particles comprise an AS surfactant that contains from 80% to 100%, preferably from 85% to 100%, of C₆-C₁₄ AS by total weight of said AS surfactant (“Mid-Cut AS”).

Other anionic surfactants suitable for inclusion into the agglomerate particles of the present invention include C₆-C₂₀ linear or branched alkyl sulfonates, C₆-C₂₀ linear or branched alkyl carboxylates, C₆-C₂₀ linear or branched alkyl phosphates, C₆-C₂₀ linear or branched alkyl phosphonates, C₆-C₂₀ alkyl N-methyl glucose amides, C₆-C₂₀ methyl ester sulfonates (MES), and combinations thereof.

Suitable non-ionic surfactants are selected from the group consisting of: C8-C18 alkyl ethoxylates (such as NEODOL® non-ionic surfactants from Shell); C6-C12 alkyl phenol alkoxylates wherein preferably the alkoxylate units are ethyleneoxy units, propyleneoxy units or a mixture thereof, C12-C18 alcohol and C6-C12 alkyl phenol condensates with ethylene oxide/propylene oxide block polymers (such as Pluronic® from BASF); alkylpolysaccharides, preferably alkylpolyglycosides; methyl ester ethoxylates; polyhydroxy fatty acid amides; ether capped poly(oxyalkylated) alcohol surfactants; and mixtures thereof.

Preferred non-ionic detersive surfactants are alkyl polyglucosides and/or alkyl alkoxylated alcohols. The alkyl alkoxylated alcohols are preferably C8-C18 alkyl alkoxylated alcohols with an average degree of alkoxylation of from 1 to 50, preferably from 1 to 30, or from 1 to 20, or from 1 to 10. More preferably, the alkyl alkoxylated alcohols are C8-C18 alkyl ethoxylated alcohols having an average degree of ethoxylation of from 1 to 10, preferably from 1 to 7, more preferably from 1 to 5, and most preferably from 3 to 7. The alkyl alkoxylated alcohol can be linear, branched, and substituted or un-substituted. Suitable nonionic surfactants also include those sold under the tradename Lutensol® from BASF.

Non-limiting examples of cationic surfactants include: the quaternary ammonium surfactants, which can have up to 26 carbon atoms include: alkoxylate quaternary ammonium (AQA) surfactants; dimethyl hydroxyethyl quaternary ammonium; dimethyl hydroxyethyl lauryl ammonium chloride; polyamine cationic surfactants; cationic ester surfactants; and amino surfactants, e.g., amido propyldimethyl amine (APA). Suitable cationic detersive surfactants also include alkyl pyridinium compounds, alkyl quaternary ammonium compounds, alkyl quaternary phosphonium compounds, alkyl ternary sulphonium compounds, and mixtures thereof.

Suitable cationic detersive surfactants are quaternary ammonium compounds having the general formula:

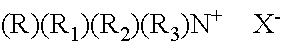

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, suitable anions include: halides, for example chloride; sulphate; and sulphonate. Suitable cationic detersive surfactants are mono-C6.18 alkyl mono-hydroxyethyl di-methyl quaternary ammonium chlorides. Highly suitable cationic detersive surfactants are mono-C₈₋₁₀ alkyl mono-hydroxyethyl di-methyl quaternary ammonium chloride, mono-C₁₀₋₁₂ alkyl mono-hydroxyethyl di-methyl quaternary ammonium chloride and mono-C₁₀ alkyl mono-hydroxyethyl di-methyl quaternary ammonium chloride.

Suitable examples of zwitterionic surfactants include: derivatives of secondary and tertiary amines, including derivatives of heterocyclic secondary and tertiary amines; derivatives of quaternary ammonium, quaternary phosphonium or tertiary sulfonium compounds; betaines, including alkyl dimethyl betaine, cocodimethyl amidopropyl betaine, and sulfo and hydroxy betaines; amine oxides, including C8-C18 (preferably C12-C18) amine oxides; N-alkyl-N,N-dimethylammino-1-propane sulfonate, where the alkyl group can be C₈ to C₁₈. Preferred zwitterionic detersive surfactants are amine oxides and/or betaines.

Suitable amphoteric surfactants include aliphatic derivatives of secondary or tertiary amines, or aliphatic derivatives of heterocyclic secondary and tertiary amines in which the aliphatic radical may be straight or branched-chain and where one of the aliphatic substituents contains at least about 8 carbon atoms, or from about 8 to about 18 carbon atoms, and at least one of the aliphatic substituents contains an anionic water-solubilizing group, e.g. carboxy, sulfonate, sulfate. Suitable amphoteric surfactants also include sarcosinates, glycinates, taurinates, and mixtures thereof.

The agglomerate particles may comprise alkalinity agents such as NaOH. This allows the detergent formulator to formulate the agglomerate detergent particle pH according to needs, for example to be compatible with the pH profile of the solid detergent product.

A preferred organic acid in such bas particles is a carboxylic acid, preferably citric acid. Other suitable acids include formic acid, acetic acid, propionic acid, butyric acid, caprylic acid and lauric acid, stearic acid, linoleic acid and acrylic acid, methacrylic acid, chloroacetic acid and citric acid, lactic acid, glyoxylic acid, acetoacetic acid, oxalic acid, malonic acid, adipic acid and phenylacetic acid, benzoic acid, salicylic acid, glycine and alanine, valine, aspartic acid, glutamic acid, lysine and phenylalanine, nicotinic acid, picolinic acid, fumaric acid, lactic acid, benzoic acid, glutamic acid; succinic acid, glycolic acid. Preferably, the organic acid is selected from the group citric acid, malic acid, succinic acid, lactic acid, glycolic acid, fumaric acid, tartaric acid, and formic acids and mixtures thereof. More preferably, the acid is citric acid, lactic acid and tartaric acid.

The agglomerate particles may comprise other ingredients, such as bleach actives, enzymes, perfumes, polymers, chelants, brighteners, hueing dyes, colorants, dye transfer inhibitors, dye fixative agents, silicones, fabric softening agents (such as clay), flocculants (such as polyethyleneoxide), suds suppressors, filler salts, and any combinations thereof.

Suitable bleach actives of the present invention may include sources of hydrogen peroxide, bleach activators (such as tetra acetyl ethylene diamine and/or alkyl oxybenzene sulphonate), bleach catalysts (such as oxaziridinium bleach catalysts, transition metal bleach catalysts, especially manganese and iron bleach catalysts), pre-formed peracids (such as phthalimidoperoxycaproic acid), and photobleach (such as zinc and/or aluminium sulphonated phthalocyanine). A particularly suitable bleach includes a combination of a source of hydrogen peroxide with a bleach activator and/or a bleach catalyst.

Suitable enzymes may be selected from the group consisting of proteases, amylases, cellulases, lipases, bleaching enzymes (such as peroxidases/oxidases), pectate lyases, which include those of plant, bacterial or fungal origin and variants thereof.

Suitable polymers may be selected from the group consisting of carboxylate polymers, soil release polymer, anti-redeposition polymers, cellulosic polymers and care polymers.

A preferred polymer is a carboxylate polymer, more preferably a co-polymer that comprises: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers. It may be preferred that the carboxylate polymer has a weight average molecular weight of at least 30 kDa, or at least 50 kDa, or even at least 70 kDa. Preferred carboxylate polymers include: polyacrylate homopolymers having a molecular weight of from 4,000 Da to 9,000 Da; maleate/acrylate random copolymers having a molecular weight of from 30,000 to 100,000 Da, or from 50,000 Da to 100,000 Da, or from 60,000 Da to 80,000 Da.

Suitable soil release polymers are sold by Clariant under the TexCare® series of polymers, e.g. TexCare® SRN240 and TexCare® SRA300. Other suitable soil release polymers are sold by Solvay under the Repel-o-Tex® series of polymers, e.g. Repel-o-Tex® SF2 and Repel-o-Tex® Crystal.

Suitable anti-redeposition polymers include polyethylene glycol polymers and/or polyethyleneimine polymers. Suitable polyethylene glycol polymers include random graft copolymers comprising: (i) hydrophilic backbone comprising polyethylene glycol; and (ii) hydrophobic side chain(s) selected from the group consisting of: C4-C25 alkyl group, polypropylene, polybutylene, vinyl ester of a saturated C1-C6 mono-carboxylic acid, C1-C6 alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide units can be less than 1, or less than 0.8, the average number of graft sites per ethylene oxide units can be in the range of from 0.5 to 0.9, or the average number of graft sites per ethylene oxide units can be in the range of from 0.1 to 0.5, or from 0.2 to 0.4. A suitable polyethylene glycol polymer is Sokalan HP22.

Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixtures thereof. Suitable carboxymethyl celluloses have a degree of carboxymethyl substitution from 0.5 to 0.9 and a molecular weight from 100,000 Da to 300,000 Da. Suitable carboxymethyl celluloses have a degree of substitution greater than 0.65 and a degree of blockiness greater than 0.45.

Suitable care polymers include cellulosic polymers that are cationically modified or hydrophobically modified. Such modified cellulosic polymers can provide anti-abrasion benefits and dye lock benefits to fabric during the laundering cycle. Suitable cellulosic polymers include cationically modified hydroxyethyl cellulose. Other suitable care polymers include dye lock polymers, for example the condensation oligomer produced by the condensation of imidazole and epichlorhydrin, preferably in ratio of 1:4:1. A suitable commercially available dye lock polymer is Polyquart® FDI (Cognis). Other suitable care polymers include amino-silicone, which can provide fabric feel benefits and fabric shape retention benefits.

Suitable chelants are selected from: diethylene triamine pentaacetate (DTPA), diethylene triamine penta(methyl phosphonic acid), ethylene diamine-N′N′-disuccinic acid (EDDS), ethylene diamine tetraacetate (EDTA), ethylene diamine tetra(methylene phosphonic acid), hydroxyethane diphosphonic acid (HEDP), hydroxyethane di(methylene phosphonic acid), NTA, MGDA, GLDA and the like. A preferred chelant is EDDS and/or GLDA and/or MGDA. The composition preferably comprises EDDS or salt thereof. Preferably the EDDS is in S,S enantiomeric form. Preferably the composition comprises 4,5-dihydroxy-m-benzenedisulfonic acid disodium salt. Preferred chelants may also function as calcium carbonate crystal growth inhibitors such as: HEDP and salt thereof; N,N-dicarboxymethyl-2-aminopentane-1,5-dioic acid and salt thereof, 2-phosphonobutane-1,2,4-tricarboxylic acid and salt thereof, and combination thereof.

Suitable hueing agents include small molecule dyes, typically falling into the Colour Index (C.I.) classifications of Acid, Direct, Basic, Reactive (including hydrolysed forms thereof) or Solvent or Disperse dyes, for example classified as Blue, Violet, Red, Green or Black, and provide the desired shade either alone or in combination. Preferred such hueing agents include Acid Violet 50, Direct Violet 9, 66 and 99, Solvent Violet 13 and any combination thereof.

Suitable dye transfer inhibitors include polyamine N-oxide polymers, copolymers of N-vinylpyrrolidone and N-vinylimidazole, polyvinylpyrrolidone, polyvinyloxazolidone, polyvinylimidazole and mixtures thereof. Preferred are poly(vinyl pyrrolidone), poly(vinylpyridine betaine), poly(vinylpyridine N-oxide), poly(vinyl pyrrolidone-vinyl imidazole) and mixtures thereof. Suitable commercially available dye transfer inhibitors include PVP-K15 and K30 (Ashland), Sokalan® HP165, HP50, HP53, HP59, HP56K, HP56, HP66 (BASF), Chromabond® S-400, S403E and S-100 (Ashland).

Suitable perfumes comprise perfume materials selected from the group: (a) perfume materials having a Clog P of less than 3.0 and a boiling point of less than 250° C. (quadrant 1 perfume materials); (b) perfume materials having a Clog P of less than 3.0 and a boiling point of 250° C. or greater (quadrant 2 perfume materials); (c) perfume materials having a Clog P of 3.0 or greater and a boiling point of less than 250° C. (quadrant 3 perfume materials); (d) perfume materials having a Clog P of 3.0 or greater and a boiling point of 250° C. or greater (quadrant 4 perfume materials); and (e) mixtures thereof. It may be preferred for the perfume to be in the form of a perfume delivery technology. Such delivery technologies further stabilize and enhance the deposition and release of perfume materials. Such perfume delivery technologies can also be used to further increase the longevity of perfume. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof.

Suitable silicones include polydimethylsiloxane and amino-silicones.

The agglomerate particles may comprise one or more filler salts, such as sodium sulfate or sodium chloride. Preferably, the agglomerate particles comprise from 30 wt % to 70 wt %, or from 40 wt % to 70 wt % of sodium sulfate as a filler salt.

### Process of Making the Agglomerate Particles

Typically, the agglomerate particles of the present invention can be prepared by any suitable method.

Suitable agglomeration process comprises the step of contacting a detersive ingredient, such as a detersive surfactant, e.g. linear alkyl benzene sulphonate (LAS) and/or alkyl alkoxylated sulphate, with an inorganic material, such as sodium carbonate and/or silica, in a mixer. The agglomeration process may also be an in-situ neutralization agglomeration process wherein an acid precursor of a detersive surfactant, such as LAS, is contacted with an alkaline material, such as carbonate and/or sodium hydroxide, in a mixer, and wherein the acid precursor of a detersive surfactant is neutralized by the alkaline material to form a detersive surfactant during the agglomeration process. Other suitable detergent ingredients that may be agglomerated include polymers, chelants, bleach activators, silicones and any combination thereof. The agglomeration process may be a high, medium or low shear agglomeration process, wherein a high shear, medium shear or low shear mixer is used accordingly. The agglomeration process may be a multi-step agglomeration process wherein two or more mixers are used, such as a high shear mixer in combination with a medium or low shear mixer. The agglomeration process can be a continuous process or a batch process. It may be preferred for the agglomerates to be subjected to a drying step, for example to a fluid bed drying step. It may also be preferred for the agglomerates to be subjected to a cooling step, for example a fluid bed cooling step. Typically, the agglomerates are subjected to particle size classification, for example a fluid bed elutriation and/or a sieve, to obtain the desired particle size distribution.

Preferably, the agglomerates have a particle size distribution such that weight average particle size is in the range of from 300 micrometers to 800 micrometers. It may be preferred for fines and over-sized agglomerates to be recycled back into the agglomeration process. Typically, over-sized particles are subjected to a size reduction step, such as grinding, and recycled back into an appropriate place in the agglomeration process, such as the mixer. Typically, fines are recycled back into an appropriate place in the agglomeration process, such as the mixer.

Preferably, liquid ingredients, such as polymer(s) and/or silicone(s) and/or non-ionic surfactant(s) and/or perfume(s) as described hereinabove, are sprayed onto the base particles in a tumbling drum mixer, e.g., a Lodige KM mixer. More preferably, a liquid mixture of nonionic surfactant(s) and perfume is sprayed onto the base particles. Such sprayed-on materials may significantly increase the surface stickiness of base particles and render their flowability even poorer. Therefore, it is more desirable to provide a flow aid to help improving their flowability in the presence of such sprayed-on materials.

### Solid Detergent Composition

The solid detergent composition of the present invention is a fully formulated, free-flowing particulate detergent composition comprising the detergent granules mentioned hereinabove. Typically, the solid detergent composition comprises the above-mentioned detergent granules, either without any other particles or in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

### Test Methods

The following techniques must be used to determine the properties of the detergent granules and detergent compositions of the invention in order that the invention described and claimed herein may be fully understood.

### Test 1: Bulk Density Measurement

The bulk density of a sample granular material is determined in accordance with Test Method B, Loose-fill Density of Granular Materials, contained in ASTM Standard E727-02, “Standard Test Methods for Determining Bulk Density of Granular Carriers and Granular Pesticides,” approved Oct. 10, 2002.

### Test 2: Surface Area Measurement

The specific surface area of a sample flow aid material is tested by N₂ gas adsorption-BET method using a JWGB with the model number of JW-BK100B, which is a standardized method described in the manual of JWGB.

### Test 3: Particle Size Distribution Test

The particle size distribution is measured by Malvern Mastersizer 2000, dry particles (e.g. PCC) is dispersed in water with around 15% obscuration, which is a dynamic laser diffraction technology.

All particulate samples are measured using the following measurement parameters:
Refractive index: 1.6;
Absorption: 0.1;
Result model: general purpose with normal and irregular option selected;
Measurement cycles per sample: 60;
Sample measurement time per cycle: 1 min;
Background measurement time: 2 min;
Obscuration filtering: off; and
Alarms: off.

Each sample is loaded into the Scirocco and then fitted with the general-purpose tray. The Scirocco is equipped with the fine mesh screen and approximately 20 to 25 flow dispersion spheres. The sample is then fed through the Mastersizer using a feeding air pressure of 3.5 bar and the vibratory feed rate is adjusted to give laser obscuration of 3 to 12%. After measurements, the results are recalculated to transform the volume-based distribution into a number-based distribution using the Result Transformation function in the Malvern software. When using the Result Transformation function, it is important to remember that the fundamental parameter which is measured is volume. Transformations to number or length should be treated with caution, particularly if:
1) The material measured shows a significant proportion (>15%) of sub-micron material.
2) If there is an unmeasured proportion of the distribution, as any errors are cubed when transforming to a number distribution.

### Test 4: Moisture Content Measurement

Two (2) grams of a sample material is tested in the Mettler Toledo HR73 Halogen moisture analyzer at 110° C. for 10 minutes. The percentage (%) of lost mass at the end of the measurement is recorded as the moisture content of the sample material.

### Test 5: Flowability Method

The flowability (ff_{c}) of each sample detergent granule is the ratio of σ1 (consolidation stress) to σc (unconfined yield strength), which is used to characterize flowability numerically: the larger ffc means the better a bulk solid flows. The flowability (ff_{c}) data is generated from a Schulze Ring Shear Tester RST-XS, while the detailed test procedure of the ring shear tester is described in detail in ASTM standard D-6773.

The specific operating condition of the Schulze Ring Shear Tester RST-XS are described hereinafter. To run a flow-ability test, firstly fill sufficient pre-conditioned detergent granules into the shear cell and form a flat powder bed by scraping off the excess material with a spatula. The mass of the filled bottom ring is then weighed and recorded. Set the filled bottom ring on the ring shear tester and place the lid concentrically to the bottom ring on the bulk solid specimen. For preshear the bottom ring is rotated clockwise (seen from the top), whereby the lid is prevented from rotation by the tie rods. The consolidation stress at pre-shear is set as 1000 Pa/2500 Pa/4000 Pa, and five different other consolidation stresses (20%, 40%, 60%, 80% and 20% vs. Pre shear setting) are also applied during the same test. The minimum shear stress required to shear the bulk sample (shear to failure) at each consolidation stress is then measured to generate a yield locus (see FIG. 4.10 in 30 D. Schulze, Powder and Bulk Solid: Behavior, Characterization, Storage and Flow, Springer, 2008). The yield locus is then used to calculate the consolidation stress, σ1 and the unconfined yield strength, σc; and the ratio of σ1 to σc is the flowability, ff_{c}.

### Test 6: Residue Measurement

The residue on fabrics treated by detergent compositions is measured as below:
1) To measure 800 ml of 25±2° C. RO water and pour it into a 1000 ml beaker. To place the beaker on a magnetic stirrer with a magnetic stirring bar in beaker, set the stirring speed to make the vortex height half the height of the water in the beaker;
2) To sample a detergent composition to 2+/−0.01 g, and pour the same into the beaker, stir for 10 min;
3) To install a Buchner funnel on a vacuum filtration flask and place black fabric in the funnel. To open the vacuum pump and slowly pour the solution from the beaker into the funnel while ensuring that the solution surface does not flow to the edge of the funnel;
4) To rinse the beaker with 200 ml of distilled water (25±2° C.) and pour the solution into the Buchner funnel. To keep the vacuum pump running for 2 minutes to suck up all the water. Then, to remove the black fabric and dry it on a hotplate; and
5) To measure residues on the black fabric by using Laundry Stain Removal Image Analysis (IA) system including Lumenera 5.0 Multi-Megapixel Enclosed Color Camera (LW575C, available from Resolution Technology, Inc.), Schneider APO-XenoPlan 1.4/23MM Compact (AZP23, available from Resolution Technology, Inc.), DL071-WHI-24-015 Ultra Bt. Diffuse Dome* WHITE NOT RED (available from Tectivity Inc.) and Laundry Stain Removal software, Calibration module—Version 4.31 with the following steps:
a) to select Stains mode,
b) to calibrate the equipment (White Balance, Snap Color Chart Image and Calibrate), c) to acquire images (snap both the reference, i.e. the black fabric before pouring the solution onto the fabric and the test sample, i.e. the black fabric after pouring the solution), d) to create mask for each stain by using pre-set mask size,
e) to measure L, a, b values and calculate VR_{reference} (Visible residue for reference) and VRₛₐₘₚₗₑ (Visible residue for sample) as well as ΔVR by using the software in which the values of VR_{reference} and VRₛₐₘₚₗₑ as well as ΔVR are determined as follows:

$${VR}_{reference} = \sqrt{{( {L}_{A} - {L}_{B} )}^{2} + {( {a}_{A} - {a}_{B} )}^{2} + {( {b}_{A} - {b}_{B} )}^{2}}$$

$${VR}_{sample} = \sqrt{{( {L}_{C} - {L}_{D} )}^{2} + {( {a}_{C} - {a}_{D} )}^{2} + {( {b}_{C} - {b}_{D} )}^{2}}$$

$$Δ VR = {VR}_{sample} - {VR}_{reference}$$

Note: A and B are respectively a peripheral area which will not be soaked by the detergent solution and a central area which will be soaked by the detergent solution in the initial fabric; C and D are respectively corresponding peripheral area which is not soaked and corresponding central area which has been soaked by the test sample in the treated fabric.

### EXAMPLES

### Example 1: Comparative Flowability and Reduced Over-Sized Particles of Detergent Granules Containing PCC vs. Common Flow Aids

Agglomerate particles with the composition as shown in Table 1 below are provided. Typically, a suitable agglomeration process comprises the step of contacting a detersive ingredient, such as a detersive surfactant, e.g., linear alkyl benzene sulphonate (LAS), with an inorganic material, such as sodium carbonate, in a mixer. The agglomeration process may also be an in-situ neutralization agglomeration process wherein an acid precursor of a detersive surfactant, such as LAS, is contacted with an alkaline material, such as carbonate, in a mixer, and wherein the acid precursor of a detersive surfactant is neutralized by the alkaline material to form a detersive surfactant during the agglomeration process. Next, such agglomerate particles are mixed with flow aid (such as zeolite or PCC) and various ingredients such as starch encapsulated perfume, brightener, mid-cut alkyl sulphate, sodium sulphate, blocky carboxymethyl cellulose, etc.

TABLE 1

| Ingredients (wt %) | Sample 1 | Sample 2 | Sample 3 | Sample 4 |
|---|---|---|---|---|
| Linear alkyl benzene | 24.7% | 24.7% | 24.7% | 24.7% |
| sulphonate (LAS) | | | | |
| Zeolite | 5% | — | 8% | — |
| PCC | — | 5% | — | 8% |
| Na₂CO₃ | 42.4% | 42.4% | 42.4% | 42.4% |
| Na₂SO₄ | 26.1% | 26.1% | 23.1% | 23.1% |
| Water | 1.5% | 1.5% | 1.5% | 1.5% |
| Miscellaneous | Balance | Balance | Balance | Balance |

The agglomeration process may be a high, medium or low shear agglomeration process, wherein a high shear, medium shear or low shear mixer is used accordingly. The agglomeration process may be a multi-step agglomeration process wherein two or more mixers are used, such as a high shear mixer in combination with a medium or low shear mixer. The agglomeration process can be a continuous process or a batch process. It may be preferred for the agglomerates to be subjected to a drying step, for example to a fluid bed drying step. It may also be preferred for the agglomerates to be subjected to a cooling step, for example a fluid bed cooling step.

Typically, the agglomerates are subjected to particle size classification, for example a fluid bed elutriation and/or a sieve, to obtain the desired particle size distribution. Preferably, the agglomerates have a particle size distribution such that weight average particle size is in the range of from 300 micrometers to 800 micrometers.

The above-mentioned detergent granules Samples 1 to 4 are then subjected to TEST 5: Flowability Method under 4000 Pa. Also, the over-sized particles were determined as follows:
1) to weight 100 g-120 g agglomerates as prepared by the method according to the present disclosure, and to put it onto a series of sieve, (typically the sieve size are 1180 micro, 850 micro, 600 micro, 425 micro, 300 micro, 250 micro, 150 micro, pan.),
2) to put onto Rotap (shaking equipment) for shaking around 5 min,
3) to take out the sieves layer by layer, and to weight the material mass from each layer of sieve and record, and
4) to calculate the over-size % as the material mass percentage on the 1180 μm sieve.

The results of flowability and over-size % are shown below.

TABLE 2

| | Flowability (ff_{c}) | |
|---|---|---|
| Samples | under 4000 Pa | Over-size (%) |
| Sample 1 (5% Zeolite) | 4.9 | 18.0% |
| Sample 2 (5% PCC) | 4.3 | 16.7% |
| Sample 3 (8% Zeolite) | 4.8 | 14.4% |
| Sample 4 (8% PCC) | 4.7 | 11.8% |

Surprisingly and unexpectedly, agglomerate detergent particles containing PCC (i.e. Samples 2 and 4) can provide a comparatively good flowability (the flowability would be considered as being good when ff_{c} is higher than 4) and reduced over-sized particles vs. agglomerate detergent particles containing zeolite (i.e. Samples 1 and 3). In this case, the introduction of PCC as a flow aid can significantly reduce the cost and time of agglomeration process to provide a competitive advantage, and at the same time, can provide a good sustainability.

### Example 2: Improved Particulate Residue of Detergent Granules Containing PCC vs. Common Flow Aids

Samples 3 and 4 of agglomerate particles were prepared as in Example 1. First of all, particulate residues were examined by a panel through visual observation. The results show that agglomerate detergent particles containing zeolite may result in particulate residue on the fabric after washing while agglomerate detergent particles containing PCC may provide an improved particulate residue.

Then, a quantitative test was conducted according to TEST 6: Residue Measurement, in which ΔVR shows the degree of visible residue (probably caused by insoluble components in the detergent compositions). A higher ΔVR means an increased level of visible residues.

The quantitative data confirms that, surprisingly and unexpectedly, agglomerate detergent particles containing PCC (i.e. Sample 4) can provide an improved residue vs. agglomerate detergent particles containing zeolite (i.e. Sample 3). It is believed that such residue benefit should be reapplied to extruded particles and flakes as well.

TABLE 3

| | VR_{reference} | VRₛₐₘₚₗₑ | |
|---|---|---|---|
| | (Visible residue | (Visible residue | |
| Samples | for reference) | for sample) | ΔVR |
| Sample 3 (8% Zeolite) | 2.194 | 5.854 | 3.659 |
| Sample 4 (8% PCC) | 2.194 | 3.740 | 1.546 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A solid detergent composition comprising a plurality of detergent granules in a format of agglomerates, extruded particles or flakes, wherein each of said detergent granules comprises a surfactant system and precipitated calcium carbonate,
wherein said detergent granules are characterized by a surfactant system content ranging from 5% to 90% and a precipitated calcium carbonate (PCC) content ranging from 0.1% to 15%, by total weight of said detergent granules,
wherein said surfactant system comprises a C10-C20 linear alkyl benzene sulphonate (LAS),
wherein the weight ratio of LAS to PCC is from 2.1 to 15,
wherein said detergent granules comprise less than 2%, by total weight of said detergent granules, of an additional flow aid which is selected from the group consisting of aluminosilicates, silicon dioxide, bentonite, clay, ground sodium carbonate, carboxymethyl cellulose (CMC) and any combinations thereof,
wherein the surfactant system and the precipitated calcium carbonate are present in a form of mixture within the detergent granules.

2. The solid detergent composition according to claim 1, wherein said precipitated calcium carbonate is characterized by:
a bulk density ranging from 100 g/L to 1000 g/L; and/or
a particle size distribution characterized by: (1) a D50 ranging from 0.1 micron to 50 microns; and/or (2) a D90 of less than 50 microns; and/or
a moisture content of less than 3%; and/or
a surface area of from 1 m²/g to 20 m²/g.

3. The solid detergent composition according to claim 1, wherein the precipitated calcium carbonate content ranges from 0.1% to 12% by total weight of said detergent granules.

4. The solid detergent composition according to claim 1, wherein the weight ratio of LAS to PCC is from 2.5 to 12.

5. The solid detergent composition according to claim 1, wherein the LAS ranges from 1% to 60% by total weight of said detergent granules.

6. The solid detergent composition according to claim 1, wherein said detergent granules comprise less than 1.5% by total weight of said detergent granules of an additional flow aid which is selected from the group of aluminosilicates, silicon dioxide, bentonite, clay, ground sodium carbonate, carboxymethyl cellulose and any combinations thereof.

7. The solid detergent composition according to claim 1, wherein the surfactant system further comprises one or more anionic surfactants selected from the group of: a C₁₀-C₂₀ linear or branched alkylalkoxylated sulfate (AAS) surfactant; a C₆-C₂₀ linear or branched unalkoxylated alkyl sulfate (AS) surfactant; and combinations thereof.

8. The solid detergent composition according to claim 1, wherein each of said detergent granules further comprises alkali metal carbonate.

9. The solid detergent composition according to claim 1, wherein each of said detergent granules further comprises one or more filler salts.

10. The solid detergent composition according to claim 1, wherein the solid detergent composition further comprises one or more ingredients selected from the group of polymers, silicones, perfumes, nonionic surfactants, and combinations thereof.

11. The solid detergent composition according to claim 1, wherein the solid detergent composition further comprises one or more enzymes.

12. The solid detergent composition according to claim 1, wherein the surfactant system and the precipitated calcium carbonate are mixed substantially homogeneously in the detergent granules.

13. The solid detergent composition according to claim 1, wherein said detergent granules are characterized by:
a bulk density ranging from 200 g/L to 2000 g/L; and/or
a particle size distribution characterized by a D50 ranging from 10 micron to 1000 microns; and/or
an oversize % ranging from 2% to 20%.

14. The solid detergent composition according to claim 1, wherein said detergent granules are substantially free of any coating made of an inorganic material which is selected from sodium carbonate, sodium sulfate, sodium chloride, silica and any combinations thereof.

15. A method of making a solid detergent composition comprising a plurality of detergent granules, comprising the steps of:
a) mixing a surfactant component and dry material into a high-speed mixer/densifier to obtain detergent agglomerates, wherein said dry material comprises precipitated calcium carbonate; and
b) drying said detergent agglomerates in a fluid-bed dryer,
wherein said detergent granules are characterized by a surfactant system content ranging from 5% to 90% and a precipitated calcium carbonate content ranging from 0.1% to 15%, by total weight of said detergent granules,
wherein said surfactant system comprises a C₁₀-C₂₀ linear alkyl benzene sulphonate (LAS),
wherein the weight ratio of LAS to PCC is from 2.1 to 15,
wherein said detergent granules comprise less than 2%, by total weight of said detergent granules, of an additional flow aid which is selected from the group consisting of aluminosilicates, silicon dioxide, bentonite, clay, ground sodium carbonate, carboxymethyl cellulose (CMC) and any combinations thereof.
